(19) United States
(12) Patent Application Publication
(10) Pub. No.: US 2026/0287077 A1
(43) Pub. Date: Sep. 24, 2026

(54) VALVE AND FLUID CONTROL DEVICE

(71) Applicant: Murata Manufacturing Co., Ltd., Nagaokakyo-shi (JP)

(72) Inventor: Masaaki FUJISAKI, Nagaokakyo-shi (JP)

(21) Appl. No.: 19/673,027

(22) Filed: May 11, 2026

Related U.S. Application Data
(63) Continuation of application No. PCT/JP2024/043179, filed on Dec. 6, 2024.

(30) Foreign Application Priority Data
Dec. 8, 2023 (JP) 2023-207374
Nov. 13, 2024 (JP) 2024-197940

(51) Int. Cl. F16K 27/02; F16K 7/17; F16K 11/044

(52) U.S. Cl. CPC F16K 27/0236; F16K 7/17; F16K 11/044; F16K 27/0263

(57) ABSTRACT

A valve includes a housing and a valve diaphragm. The housing includes a first housing member and a second housing member. The first housing member includes a first end member including a first surface and a second surface, and a first side wall member having a ring shape and directly or indirectly connected to the first end member. The first side wall member includes a third surface on a side opposite to a side connected to a portion of the second surface. The second housing member includes a second end member including a fourth surface and a fifth surface facing a portion of the second surface, and a second side wall member having a ring shape and directly or indirectly connected to the second end member.

### CROSS REFERENCE TO RELATED APPLICATION

This is a continuation of International Application No. PCT/JP2024/043179 filed on Dec. 6, 2024 which claims priority from Japanese Patent Application No. 2023-207374 filed on Dec. 8, 2023 and Japanese Patent Application No. 2024-197940 filed on Nov. 13, 2024. The contents of these applications are incorporated herein by reference in their entireties.

### BACKGROUND OF THE DISCLOSURE

### Field of the Disclosure

The present disclosure relates to a valve that regulates a flow of fluid, such as gas, and a fluid control device including the valve in combination with a pump.

### Description of the Related Art

International Publication No. 2022/234778 describes a valve. The valve described in International Publication No. 2022/234778 includes a first vent hole that communicates with a pump, a second vent hole that communicates with a cuff, an exhaust hole through which air in the cuff is exhausted, and a diaphragm for regulating flow.

The valve regulates the flow of gas by movement of the diaphragm. More specifically, the diaphragm is deformed in response to the flow of gas, thereby establishing a first state in which the first vent hole and the second vent hole communicate with each other and a second state in which the second vent hole and the exhaust hole communicate with each other. In the first state, gas is supplied from the first vent hole and delivered through the second vent hole. In the second state, gas is introduced through the second vent hole and exhausted through the exhaust hole.

### BRIEF SUMMARY OF THE DISCLOSURE

In the valve according to the related art described in International Publication No. 2022/234778, it is difficult to ensure reliable communication between the second vent hole and the exhaust hole in a steady state. A steady state is a state in which gas is not supplied through the first vent hole.

Accordingly, a possible benefit of the present disclosure is to ensure reliable communication between the second vent hole and the exhaust hole in a steady state and perform reliable switching between the first state, in which the first vent hole and the second vent hole communicate with each other, and the second state, in which the second vent hole and the exhaust hole communicate with each other.

A valve according to an embodiment of the present disclosure includes a housing and a valve diaphragm. The housing includes a first housing member and a second housing member. The first housing member includes a first end member including a first surface and a second surface, and a first side wall member having a ring shape and directly or indirectly connected to the first end member. The first side wall member includes a third surface on a side opposite to a side connected to a portion of the second surface. The second housing member includes a second end member including a fourth surface and a fifth surface facing a portion of the second surface, and a second side wall member having a ring shape and directly or indirectly connected to the second end member. The second side wall member includes a sixth surface facing or joined to a portion of the fifth surface and a seventh surface facing or joined to a portion of the third surface of the first side wall member.

The first end member includes a plurality of first vent holes through which the first surface and the second surface communicate with each other, and a first valve seat connected to the second surface and disposed within the ring of the first side wall member in a plan view of the second surface. The first valve seat includes a first top surface. The first top surface is positioned closer to the fifth surface than the second surface in a thickness direction of the first housing member.

The second end member has a second vent hole through which the fourth surface and the fifth surface communicate with each other.

The second side wall member includes an exhaust hole that communicates with the seventh surface, and a second valve seat disposed between an inner side surface of the ring of the second side wall member and the exhaust hole in a front view of the fourth surface. The second valve seat includes a second top surface on a side on which the seventh surface is provided.

The valve diaphragm is disposed in the ring of the first side wall member and the ring of the second side wall member, and includes a first portion that overlaps the first valve seat, a second portion that overlaps the second valve seat, and an outer edge portion positioned on an outer peripheral side of the second portion when viewed in a height direction in which the first housing member and the second housing member are arranged. While the outer edge portion of the valve diaphragm is held between the first housing member and the second housing member, the second portion is closer to the first surface than the first portion when viewed in a lateral direction orthogonal to the height direction. A thickness of the first portion and a thickness of the second portion are greater than a thickness of the outer edge portion.

With this configuration, the valve diaphragm is deformed by gas that flows through the space within the rings of the first side wall member and the second side wall member (internal space of the housing), thereby switching between a first state, in which the first vent holes and the second vent hole communicate with each other, and a second state, in which the second vent hole and the exhaust hole communicate with each other. In addition, when gas is not supplied through the first vent holes, a sufficient distance can be readily ensured between the valve diaphragm and the top surface of the second valve seat. Accordingly, when gas is not supplied through the first vent holes, the second vent hole and the exhaust hole can reliably communicate with each other.

According to the present disclosure, the second vent hole and the exhaust hole reliably communicate with each other in a steady state in which gas is not supplied through the first vent holes, and switching between the first state, in which the first vent holes and the second vent hole communicate with each other, and the second state, in which the second vent hole and the exhaust hole communicate with each other, can be reliably performed.

### BRIEF DESCRIPTION OF THE SEVERAL VIEWS OF THE DRAWINGS

FIG. 1 is a sectional side view of the valve according to a first embodiment.

FIG. 2 is an exploded perspective view of the valve according to the first embodiment.

FIG. 3 is an exploded perspective view of the valve according to the first embodiment.

FIG. 4A illustrates a state before a valve diaphragm is held between a first housing member and a second housing member, and FIG. 4B illustrates a state in which the valve diaphragm is held between the first housing member and the second housing member.

FIGS. 5A and 5B are sectional side views of the valve in operation.

FIG. 6 is a sectional side view of a valve according to a second embodiment.

FIG. 7 is an exploded perspective view of the valve according to the second embodiment.

FIG. 8A is a sectional side view of a valve according to a third embodiment, and FIG. 8B is a sectional side view illustrating a valve according to the third embodiment having another configuration.

FIG. 9 is an exploded perspective view of the valve according to the third embodiment.

FIG. 10 is an exploded perspective view of the valve according to the third embodiment.

FIG. 11 is an exploded perspective view of a valve according to a fourth embodiment.

FIG. 12 is an exploded perspective view of the valve according to the fourth embodiment.

FIG. 13 is a sectional side view of a valve according to a fifth embodiment.

FIG. 14 is an exploded perspective view of the valve according to the fifth embodiment.

FIG. 15 is an exploded perspective view of a valve according to a sixth embodiment.

FIG. 16 is an exploded perspective view of the valve according to the sixth embodiment.

FIG. 17 is an exploded perspective view of a valve according to a seventh embodiment.

FIG. 18 is an exploded perspective view of the valve according to the seventh embodiment.

FIG. 19A is a plan view of a second housing member, and FIG. 19B is a sectional view of FIG. 19A taken along line A-A.

FIG. 20A is a plan view of the second housing member, and FIG. 20B is a sectional view of FIG. 20A taken along line B-B.

FIG. 21A is a plan view of the second housing member, and FIG. 21B is a sectional view of FIG. 21A taken along line C-C.

FIGS. 22A and 22B are sectional views of a valve according to an eighth embodiment.

FIG. 23 is a sectional side view of a fluid control device according to a ninth embodiment.

FIG. 24 is a sectional side view of the fluid control device according to the ninth embodiment with a cuff.

FIG. 25 is an exploded perspective view of the fluid control device according to the ninth embodiment.

FIG. 26 is an exploded perspective view of a fluid control device according to a tenth embodiment.

FIGS. 27A and 27B are sectional side views illustrating variations of the shape of the cuff.

### DESCRIPTION OF EMBODIMENTS

### First Embodiment

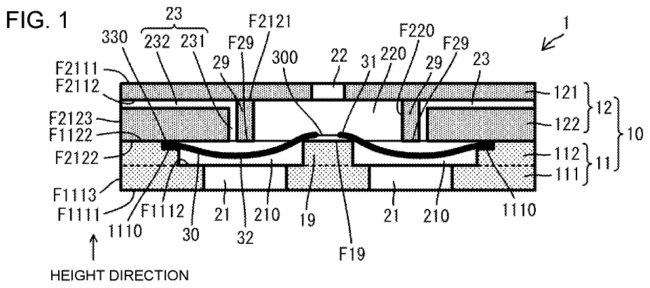

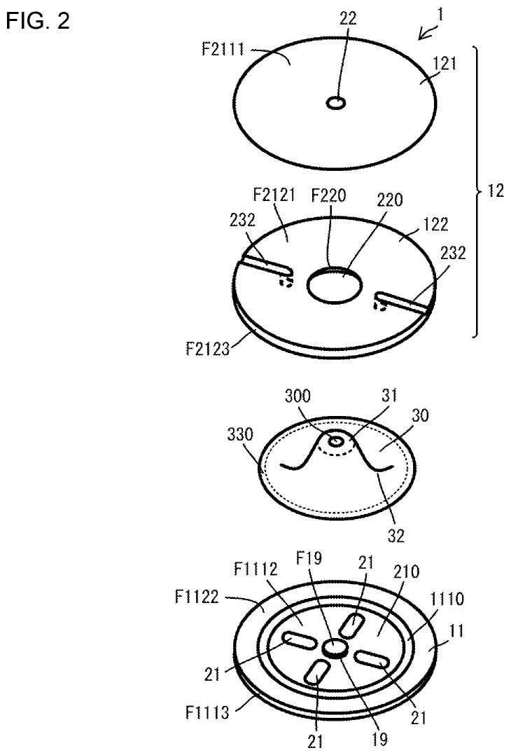

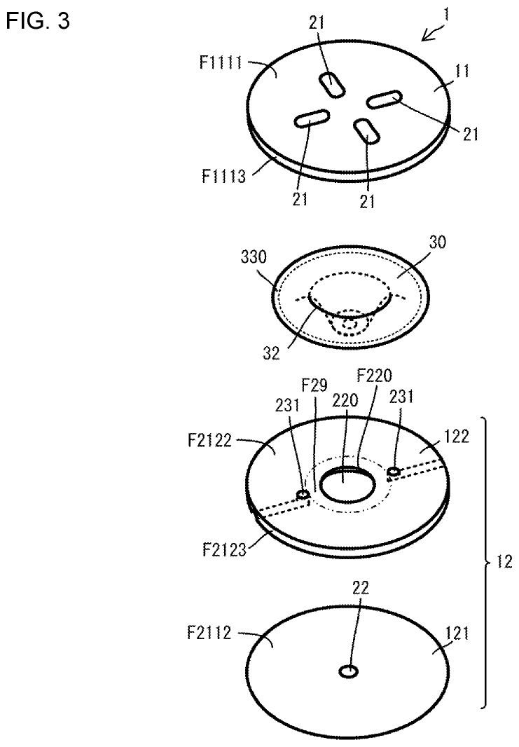

A valve according to the first embodiment of the present disclosure will now be described with reference to the drawings. FIG. 1 is a sectional side view of the valve according to the first embodiment. FIGS. 2 and 3 are exploded perspective views of the valve according to the first embodiment. FIG. 2 is an exploded perspective view as viewed from a second-housing-member side, and FIG. 3 is an exploded perspective view as viewed from a first-housing-member side.

As illustrated in FIGS. 1, 2, and 3, the valve 1 includes a housing 10 and a valve diaphragm 30. The housing 10 includes a first housing member 11 and a second housing member 12. The first housing member 11 and the second housing member 12 are arranged in a height direction of the valve 1 and the housing 10. The first housing member 11 and the second housing member 12 are configured as described below so that the housing 10 has an internal space enclosed by the first housing member 11 and the second housing member 12. The valve diaphragm 30 is disposed in the internal space.

The first housing member 11 has a three-dimensional shape that is circular when viewed in the height direction. The first housing member 11 includes a first space 210, a plurality of first vent holes 21, a first valve seat 19, and a recess 1110. The recess 1110 corresponds to the “first-member recess” of the present disclosure.

More specifically, the first housing member 11 includes a first end member 111 and a first side wall member 112. The first end member 111 and the first side wall member 112 are formed integrally with each other.

The first end member 111 has a plate shape that is circular when viewed in the height direction. The first end member 111 includes a first surface F1111 and a second surface F1112. The first side wall member 112 has a ring shape that is circular when viewed in the height direction. The first side wall member 112 is connected to the second surface F1112, and includes a third surface F1122 opposite to the connecting surface. The first housing member 11, including the first end member 111 and the first side wall member 112 formed integrally with each other, includes an outer side surface F1113.

With this configuration, the space within the ring of the first side wall member 112 serves as a first space 210 in the first housing member 11.

The first space 210 has a circular shape when viewed in the height direction, and is defined by a recess that is recessed from the third surface F1122. The second surface F1112 serves as the bottom surface of the first space 210. The first space 210 opens in the third surface F1122. When the first housing member 11 is viewed in the height direction, the center of the first space 210 coincides or substantially coincides with the center of the first housing member 11.

The first end member 111 includes the first vent holes 21. The first vent holes 21 extend between and through the first surface F1111 and the second surface F1112. The first vent holes 21 communicate with the first space 210. The first vent holes 21 are oblong when viewed in the height direction.

When the first housing member 11 is viewed in the height direction, the first vent holes 21 are arranged radially with respect to the center of the first housing member 11.

The recess 1110 is recessed from the third surface F1122. The recess 1110 has an annular shape when viewed in the height direction, and communicates with the outer peripheral edge of the first space 210. The depth of the recess 1110 is less than the thickness of the valve diaphragm 30. When the valve diaphragm 30 is fixed, for example, to the bottom surface of the recess 1110 with an adhesive or the like, the depth of the recess 1110 may be set taking the thickness of the adhesive into account.

The first valve seat 19 is cylindrical. The first valve seat 19 is shaped to project from the second surface F1112 toward the third surface F1122. The first valve seat 19 is disposed in the first space 210. The first valve seat 19 includes a first top surface F19, which is circular, at an end thereof projecting from the second surface F1112 (bottom surface defining the first space 210). The first top surface F19 is at substantially the same position as the position of the third surface F1122 in the height direction of the housing 10.

The second housing member 12 has a three-dimensional shape that is circular when viewed in the height direction. The second housing member 12 includes a second space 220, a second vent hole 22, third vent holes 23, and a second valve seat 29. The third vent holes 23 correspond to the “exhaust hole” of the present disclosure.

More specifically, the second housing member 12 includes a second end member 121 and a second side wall member 122. The second end member 121 and the second side wall member 122 are separate members.

The second end member 121 has a plate shape that is circular when viewed in the height direction. The second end member 121 includes a fourth surface F2111 and a fifth surface F2112. The second side wall member 122 has a ring shape that is circular when viewed in the height direction. The second side wall member 122 includes a sixth surface F2121 and a seventh surface F2122. The sixth surface F2121 is connected to the fifth surface F2112. The sixth surface F2121 and the fifth surface F2112 may be connected (joined) in direct contact with each other, or be indirectly connected (joined) with another member interposed therebetween. The second housing member 12 includes an outer side surface F2123 and an inner side surface F220 facing the space within the ring.

With this configuration, the space within the ring of the second side wall member 122 serves as the second space 220 in the second housing member 12.

The second space 220 is circular when viewed in the height direction, and opens in the seventh surface F2122. When the second housing member 12 is viewed in the height direction, the center of the second space 220 coincides or substantially coincides with the center of the second housing member 12.

The diameter of the second space 220 viewed in the height direction (the diameter of the circle defined by the inner side surface F220 of the second side wall member 122) is less than the diameter of the first space 210 viewed in the height direction (the diameter of the circle defined by the inner side surface of the first side wall member 112). The diameter of the second space 220 viewed in the height direction is greater than the diameter of the first valve seat 19 (first top surface F19).

The second end member 121 has the second vent hole 22. The second vent hole 22 extends between and through the fourth surface F2111 and the fifth surface F2112. The second vent hole 22 communicates with the second space 220. The second vent hole 22 has a cylindrical shape that is circular when viewed in the height direction.

The diameter of the second vent hole 22 viewed in the height direction is less than the diameter of the second space 220 viewed in the height direction. When the second housing member 12 is viewed in the height direction, the second vent hole 22 is located to overlap the center of the second space 220.

When the second housing member 12 is viewed in the height direction, the third vent holes 23 are located outside the inner side surface F220. The third vent holes 23 include respective vertical holes 231 and respective horizontal holes 232.

The vertical holes 231 extend in the height direction of the housing 10. The vertical holes 231 are located at a predetermined distance outward from the inner side surface F220 defining the second space 220. One end of each vertical hole 231 opens in the seventh surface F2122. The horizontal holes 232 extend orthogonally to the height direction of the housing 10. The horizontal holes 232 are defined by grooves recessed from the sixth surface F2121 of the second side wall member 122 and the fifth surface F2112 of the second end member 121 that covers the grooves. One end of each horizontal hole 232 communicates with the other end of the corresponding vertical hole 231. Each horizontal hole 232 opens in the outer side surface F2123. With this configuration, the third vent holes 23 allow communication between the seventh surface F2122 and the outer side surface F2123 of the second housing member 12.

The second valve seat 29 has an annular shape when viewed in the height direction. When the second housing member 12 is viewed in the height direction, the second valve seat 29 is a three-dimensional portion provided between the inner side surface F220 defining the second space 220 and a circle to which the third vent holes 23 are externally tangent. With this configuration, the second valve seat 29 has a second top surface F29 at substantially the same position as the position of the seventh surface F2122 in the height direction of the housing 10.

The first housing member 11 and the second housing member 12 are connected to each other such that the third surface F1122 and the seventh surface F2122 face each other. The third surface F1122 and the seventh surface F2122 may be connected directly or indirectly with another member interposed therebetween. The housing 10 is thus configured. In this case, when the housing 10 is viewed in the height direction, openings of the third vent holes 23 in the seventh surface F2122 overlap the first vent holes 21.

The first space 210 and the second space 220 communicate with each other and define the internal space of the valve 1. The first space 210 and the third vent holes 23 communicate with each other. In this case, the openings of the vertical holes 231 of the third vent holes 23 in the seventh surface F2122 are closer to the outer peripheral edge of the first space 210 (inner side surface of the first side wall member 112) than the center of the first space 210.

The valve diaphragm 30 is circular in plan view. The valve diaphragm 30 has a through hole 300 at the center when viewed in the height direction. The valve diaphragm 30 is made of a metal film, a flexible polymer film, or the like that is deformable by an air flow. The valve diaphragm 30 includes a first portion 31, a second portion 32, and an outer edge portion 330.

The outer edge portion 330 of the valve diaphragm 30 has an annular shape and is disposed in the recess 1110. The outer edge portion 330 of the valve diaphragm 30 is held between the bottom surface of the recess 1110 and the seventh surface F2122 of the second side wall member 122 of the second housing member 12. Thus, the valve diaphragm 30 is fixed to the housing 10 such that a portion of the valve diaphragm 30 closer to the center than the outer edge portion 330 is deformable. In this case, the valve diaphragm 30 is disposed to divide the internal space of the housing 10 into a space adjacent to the first vent holes 21 and a space adjacent to the second vent hole 22. In plan view, the outer shape of the valve diaphragm 30 is larger than the outer shape of the first space 210.

The first portion 31 is a circular portion including the center when viewed in the height direction and including a region in which the through hole 300 is formed. The second portion 32 is an annular portion closer to the outer edge portion 330 than the first portion 31. When the valve diaphragm 30 is viewed in the height direction, the second portion 32 is shaped to surround the first portion 31.

When viewed in the height direction of the housing 10, the first portion 31 overlaps the first valve seat 19. When the housing 10 is viewed in the height direction, the second portion 32 overlaps the second valve seat 29.

The valve diaphragm 30 is shaped such that the first portion 31 bulges toward the second vent hole 22 beyond the second portion 32 in the height direction of the housing 10. The valve diaphragm 30 is shaped such that the second portion 32 is recessed toward the first vent holes 21 beyond the outer edge portion (portion disposed in the recess 1110) in the height direction of the housing 10. In other words, the valve diaphragm 30 is curved such that the second portion 32 is closer to the first surface F1111 than the first portion 31 when viewed in a horizontal direction orthogonal to the height direction of the housing 10.

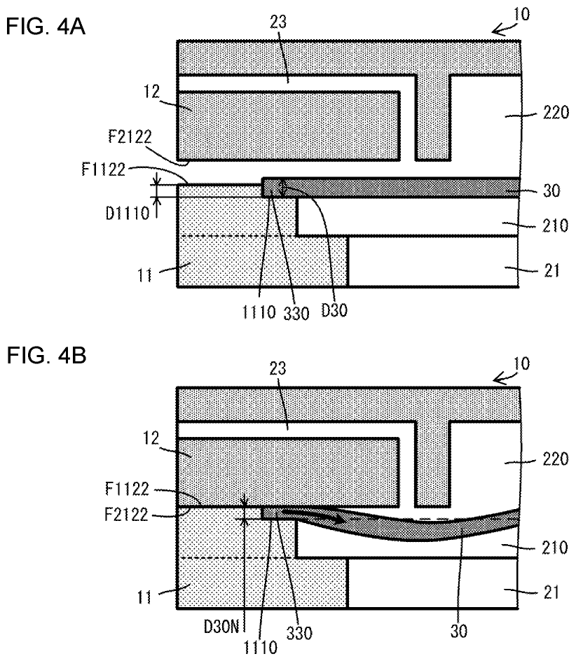

The above-described shape of the valve diaphragm 30 may be formed when, for example, the valve 1 is assembled. FIG. 4A illustrates a state before the valve diaphragm is held between the first housing member and the second housing member, and FIG. 4B illustrates a state in which the valve diaphragm is held between the first housing member and the second housing member.

As illustrated in FIG. 4A, a depth D1110 of the recess 1110 is less than a thickness D30 of the valve diaphragm 30 (at least the thickness of the outer edge portion 330). In this case, when the valve diaphragm 30 is placed in the recess 1110 and held between the first housing member 11 and the second housing member 12, the outer edge portion 330 is compressed by the first housing member 11 and the second housing member 12. Accordingly, as illustrated in FIG. 4B, the thickness of the outer edge portion 330 of the valve diaphragm 30 is reduced. As a result, the valve diaphragm 30 is pushed toward the center by an amount corresponding to the reduction in volume at the outer edge portion 330. As a result of the valve diaphragm 30 being pushed inward, a portion of the valve diaphragm 30 inside the outer edge portion 330 becomes slack.

In the region closer to the center than the recess 1110, the first space 210 opens in the first housing member 11, and the seventh surface F2122 extends continuously in the second housing member 12. Accordingly, the slack portion of the valve diaphragm 30 extends into the first space 210. The first portion 31 of the valve diaphragm 30 is in contact with the first valve seat 19 on the side adjacent to the first housing member 11. As a result, the valve diaphragm 30 is curved such that the second portion 32 bulges into the first space 210. Thus, the valve diaphragm 30 is disposed in the ring of the first side wall member 112 of the first housing member 11 and the ring of the second side wall member 122 of the second housing member 12. With the configuration described below, the valve diaphragm 30 can switch between a state in which the first vent holes 21 and the second vent hole 22 communicate with each other and a state in which the first vent holes 21 and the second vent hole 22 do not communicate with each other.

With this configuration, when gas is not introduced through the first vent holes 21 (in a stopped state (included in a second state)), the first portion 31 of the valve diaphragm 30 is in contact with the first valve seat 19, and the second portion 32 is separated from the second valve seat 29. Thus, when gas is not introduced through the first vent holes 21, the valve 1 can reliably provide communication between the second vent hole 22 and the third vent holes 23. In other words, when the operation of the valve 1 is stopped, the valve 1 can reliably provide communication between the second vent hole 22 and the third vent holes 23.

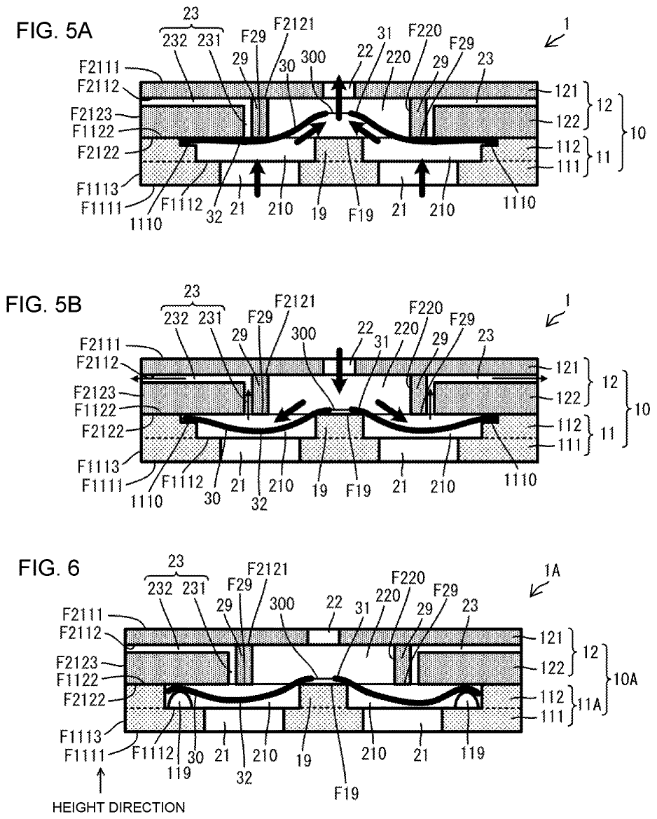

The valve 1 having the above-described configuration operates as described below. FIGS. 5A and 5B are sectional side views of the valve in operation. FIG. 5A illustrates the valve diaphragm in a first state in which gas is introduced through the first vent holes. FIG. 5B illustrates the valve diaphragm in another type of second state in which gas is introduced through the second vent hole.

### First State

When gas is introduced through the first vent holes 21 by a pump or the like described below, the gas (air flow) flows through the first space 210 and comes into contact with the valve diaphragm 30. The gas (air flow) pushes the valve diaphragm 30 toward the second space 220.

Accordingly, the valve diaphragm 30 moves away from the first valve seat 19. This allows the first space 210 and the second space 220 to communicate with each other. As a result, the first vent holes 21 communicate with the second vent hole 22 through the first space 210 and the second space 220. In other words, the valve 1 can cause the gas introduced through the first vent holes 21 from the space outside the first surface F1111 to be discharged to the space outside the fourth surface F2111.

At this time, the valve diaphragm 30 is pushed toward the second housing member 12 by the gas introduced into the first space 210. Accordingly, the second portion 32 of the valve diaphragm 30 comes into contact with the second top surface F29 of the second valve seat 29.

Accordingly, the second space 220 and the third vent holes 23 do not communicate with each other. As a result, the valve 1 can reduce leakage of gas introduced into the second space 220 from the first space 210 to the third vent holes 23. Thus, the valve 1 can suppress a reduction in the efficiency of gas transfer from the space outside the first surface F1111 to the space outside the fourth surface F2111.

### Exhaust State Included in Second State

When, for example, gas is exhausted from a cuff described below and thereby introduced through the second vent hole 22, the gas (air flow) flows through the second space 220 and comes into contact with the valve diaphragm 30. The gas (air flow) pushes the valve diaphragm 30 toward the first space 210.

Accordingly, the second portion 32 of the valve diaphragm 30 moves away from the second valve seat 29 and enters the first space 210. This allows the second space 220 and the third vent holes 23 to communicate with each other. As a result, the second vent hole 22 communicates with the third vent holes 23 through the second space 220 (and a portion of the first space 210). In other words, the valve 1 can cause the gas introduced through the second vent hole 22 from the space outside the fourth surface F2111 to be discharged to the space outside the outer side surface F2123.

At this time, the valve diaphragm 30 is pushed toward the first housing member 11 by the gas introduced into the second space 220. Accordingly, the first portion 31 of the valve diaphragm 30 comes into contact with the first top surface F19 of the first valve seat 19.

Accordingly, the second space 220 and the first space 210 do not communicate with each other. As a result, the valve 1 can reduce leakage of gas introduced into the second space 220 from the second vent hole 22 to the first vent holes 21. Thus, the valve 1 can suppress a reduction in the efficiency of gas transfer from the space outside the fourth surface F2111 to the space outside the outer side surface F2123.

Thus, the valve diaphragm 30 and the first valve seat 19 form a check valve. The valve diaphragm 30 and the second valve seat 29 form an exhaust valve.

As described above, in a steady state in which gas is not supplied through the first vent holes 21, the valve 1 allows the second vent hole 22 and the third vent holes 23 (exhaust holes) to reliably communicate with each other.

In addition, the valve 1 can reliably switch between the first state in which the first vent holes 21 and the second vent hole 22 communicate with each other and the second state in which the second vent hole 22 and the third vent holes 23 (exhaust holes) communicate with each other.

In addition, when the housing 10 is viewed in the height direction, the first vent holes 21 and the third vent holes 23 overlap each other. Accordingly, when gas is exhausted, the valve diaphragm 30 can be displaced toward the first surface F1111 by a large distance. Thus, the distance between the valve diaphragm 30 and the second valve seat 29 can be increased when gas is exhausted. As a result, according to the valve 1, a gas flow passage through which gas is exhausted can be increased, allowing the gas to be exhausted more quickly.

Additionally, a portion of the valve diaphragm 30 around the outer peripheral edge communicates with the outside of the housing 10 (atmosphere) through the third vent holes 23. Thus, the pressure in the third vent holes 23 is substantially atmospheric pressure. Accordingly, when the introduction of gas through the first vent holes 21 is stopped and the pressure in the first vent holes 21 and the first space 210 drops to the outside pressure (atmospheric pressure), the pressure difference between both sides of the valve diaphragm 30 is small, and the portion around the outer peripheral edge is not pressurized. Thus, the valve 1 can reduce the pressure difference applied to the valve diaphragm 30 in response to a change between the two states, thereby reducing damage to the valve diaphragm 30.

In addition, when the valve 1 is viewed in the height direction, the second valve seat 29 surrounds the first valve seat 19. In other words, when the valve 1 is viewed in the height direction, the exhaust valve is positioned to surround the check valve. When the valve 1 is viewed in the height direction, the central axis of the valve diaphragm 30 substantially coincides with the center of the first valve seat 19.

Accordingly, in the exhaust state, gas flows from the second vent hole 22 to the third vent holes 23 evenly with respect to the central axis of the valve diaphragm 30. As a result, the valve 1 can reduce leakage from the second vent hole 22 to the first vent holes 21, thereby improving backflow prevention performance and reliably exhausting gas.

In addition, when the valve 1 is viewed in the height direction, the openings of the third vent holes 23 in the seventh surface F2122 (portions that communicate with the first space 210) are arranged on the same circle centered on the central axis of the valve diaphragm 30. In addition, the central axis of the valve diaphragm 30 passes through the midpoint between the openings of the third vent holes 23 in the seventh surface F2122 (portions that communicate with the first space 210). Thus, when viewed in the height direction, the openings of the third vent holes 23 in the seventh surface F2122 (portions that communicate with the first space 210) are arranged symmetrically with respect to the check valve.

Accordingly, gas that flows to the third vent holes 23 applies stress to the valve diaphragm 30 substantially evenly about the central axis. Thus, the stress applied to the valve diaphragm 30 is less likely to be distributed unevenly, so that the valve 1 can reliably exhaust gas and reduce local damage to the valve diaphragm 30.

The number of third vent holes 23 is two in the above-described configuration, but is not limited to two. When three or more third vent holes 23 are provided, the third vent holes 23 may be arranged at equal angular intervals along the same circle centered on the central axis of the valve diaphragm 30.

The valve 1 can be determined as having the above-described configuration when, for example, a thickness D30N (FIG. 4B) of the outer edge portion 330 held between the first housing member 11 and the second housing member 12 is less than the thickness of the valve diaphragm 30 in a region around the through hole 300 (first portion 31). The depth D1110 of the recess 1110 may be used instead of the thickness D30N of the outer edge portion 330. The height of the recess 1110 may be measured by, for example, X-ray transmission observation or observation of a cross section after cutting. cl Second Embodiment

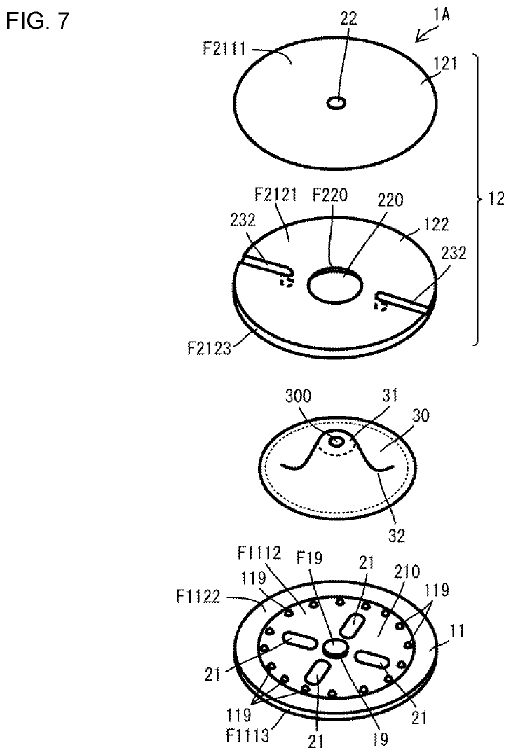

A valve according to a second embodiment of the present disclosure will now be described with reference to the drawings. FIG. 6 is a sectional side view of the valve according to the second embodiment. FIG. 7 is an exploded perspective view of the valve according to the second embodiment. FIG. 7 is an exploded perspective view as viewed from a second-housing-member side.

As illustrated in FIGS. 6 and 7, the valve 1A according to the second embodiment differs from the valve 1 according to the first embodiment in the fixing structure of the valve diaphragm 30. Other features of the valve 1A according to the second embodiment are similar to those of the valve 1 according to the first embodiment, and description thereof will be omitted. Description of effects of the valve 1A according to the second embodiment that are the same as those of the valve 1 according to the first embodiment will also be omitted.

The first housing member 11A includes a plurality of projections 119. The projections 119 are semispherical. The projections 119 are shaped to project from the second surface F1112 (bottom surface defining the first space 210) toward the third surface F1122 in the height direction. The projections 119 correspond to the “second projections” of the present disclosure.

The projections 119 are disposed near the inner side surface of the first housing member 11A defining the first space 210. When the valve 1A is viewed in the height direction, the projections 119 are disposed outward from the openings of the third vent holes 23 in the seventh surface F2122. The projections 119 are arranged at equal angular intervals on the same circle centered on the center of the first valve seat 19 (central axis of the valve diaphragm 30). In other words, when viewed in the height direction, the projections 119 are arranged in a ring shape at equal intervals along the circumferential direction of the ring.

The distance in the height direction between the projections 119 and the seventh surface F2122 is less than the thickness of the valve diaphragm 30. Accordingly, when the valve diaphragm 30 is fixed to the housing 10A, the projections 119 are pressed into the valve diaphragm 30. As a result, the valve diaphragm 30 is less likely to be separated from the housing 10A during operation.

Since the projections 119 are arranged in a ring shape at equal intervals in the circumferential direction of the ring, the valve diaphragm 30 is evenly fixed along the outer peripheral edge thereof. Accordingly, in the valve 1A, the valve diaphragm 30 can be more reliably fixed. cl Third Embodiment

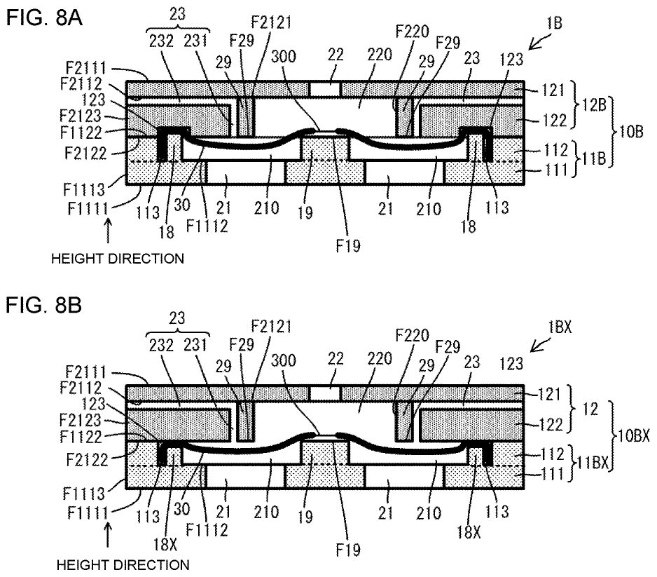

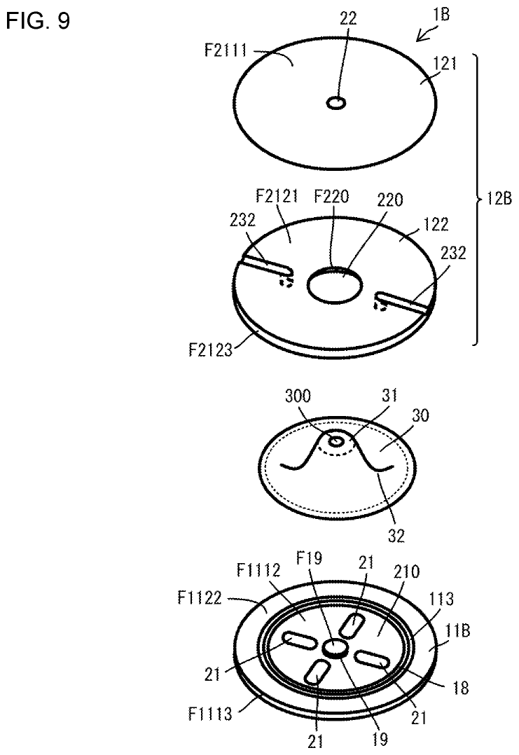

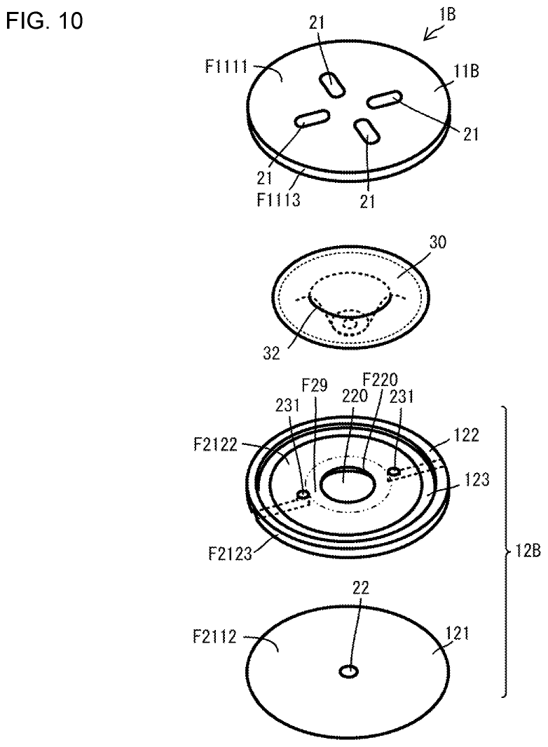

A valve according to a third embodiment of the present disclosure will now be described with reference to the drawings. FIGS. 8A and 8B are sectional side views of the valve according to the third embodiment. FIGS. 9 and 10 are exploded perspective views of the valve according to the third embodiment. FIG. 9 is an exploded perspective view as viewed from a second-housing-member side, and FIG. 10 is an exploded perspective view as viewed from a first-housing-member side.

As illustrated in FIGS. 8A, 9 and 10, the valve 1B according to the third embodiment differs from the valve 1 according to the first embodiment in the fixing structure of the valve diaphragm 30. Other features of the valve 1B according to the third embodiment are similar to those of the valve 1 according to the first embodiment, and description thereof will be omitted. Description of effects of the valve 1B according to the third embodiment that are the same as those of the valve 1 according to the first embodiment will also be omitted.

A first housing member 11B includes a projection 18. When a housing 10B is viewed in the height direction, the projection 18 has an annular shape. When the housing 10B is viewed in the height direction, the projection 18 is disposed outward from the openings of the third vent holes 23 in the seventh surface F2122. The projection 18 projects beyond the third surface F1122 in the height direction of the housing 10B. The projection 18 corresponds to the “first projection” of the present disclosure. A groove 113 having an annular shape in plan view is formed outside the projection 18.

The second housing member 12B includes a recess 123. When the housing 10B is viewed in the height direction, the recess 123 has an annular shape. The recess 123 is recessed from the seventh surface F2122. When the housing 10B is viewed in the height direction, the recess 123 is disposed outward from the openings of the third vent holes 23 in the seventh surface F2122. The recess 123 corresponds to the “second-member recess” in the present disclosure.

When the housing 10B is viewed in the height direction, the recess 123 and the projection 18 overlap each other, and the recess 123 and the groove 113 at least partially overlap each other. The distance between the bottom surface of the recess 123 (upper surface of the recess in FIG. 8A) and the end of the projection 18 in the height direction is less than the thickness of the valve diaphragm 30.

The outer peripheral edge of the valve diaphragm 30 is disposed in the groove 113. A portion of the valve diaphragm 30 between the outer peripheral edge and the second portion 32 is held between the bottom surface of the recess 123 and the projection 18. In this case, the projection 18 is pressed into the portion of the valve diaphragm between the outer peripheral edge and the second portion 32. As a result, the valve diaphragm 30 is less likely to be separated from the housing 10B during operation.

In this configuration, the valve diaphragm 30 is shaped to extend obliquely downward into the first space 210 from a fixed portion between the bottom surface of the recess 123 and the projection 18. Accordingly, in the valve 1B, the valve diaphragm 30 can easily maintain the shape in which the second portion 32 is closer to the first surface F1111 than the first portion 31.

In the valve 1B, the groove 113 can be omitted. However, when the groove 113 is provided, the outer peripheral edge of the valve diaphragm 30 can be more reliably fixed.

A valve 1BX illustrated in FIG. 8B differs from the valve 1B in that the recess 123 in the second side wall member 122B is omitted and that the projection 18X has a different height. Other features of the valve 1BX are similar to those of the valve 1B, and description thereof will be omitted.

The housing 10BX of the valve 1BX includes a first housing member 11BX. The first housing member 11BX includes the projection 18X. When the valve 1BX is viewed in the height direction, the projection 18X is located closer to the outer peripheral edge than the openings of the third vent holes 23 of the second housing member 12 in the seventh surface F2122, such that the projection 18X overlaps the seventh surface F2122. The projection 18X has a top surface at a location closer to the second surface F1112 than the third surface F1122 in the height direction. The projection 18X has a ring shape or a partial ring shape when viewed in the height direction. The distance between the top surface of the projection 18X and the seventh surface F2122 is less than the thickness of the valve diaphragm 30.

When viewed in the height direction, the groove 113 is closer to the outer side surface F1113 than the projection 18X. The groove 113 is recessed from the third surface F1122 and has a ring shape or a partial ring shape when viewed in the height direction.

The outer peripheral edge of the valve diaphragm 30 is disposed in the groove 113. A portion of the valve diaphragm 30 is held between the seventh surface F2122 and the projection 18X.

### Fourth Embodiment

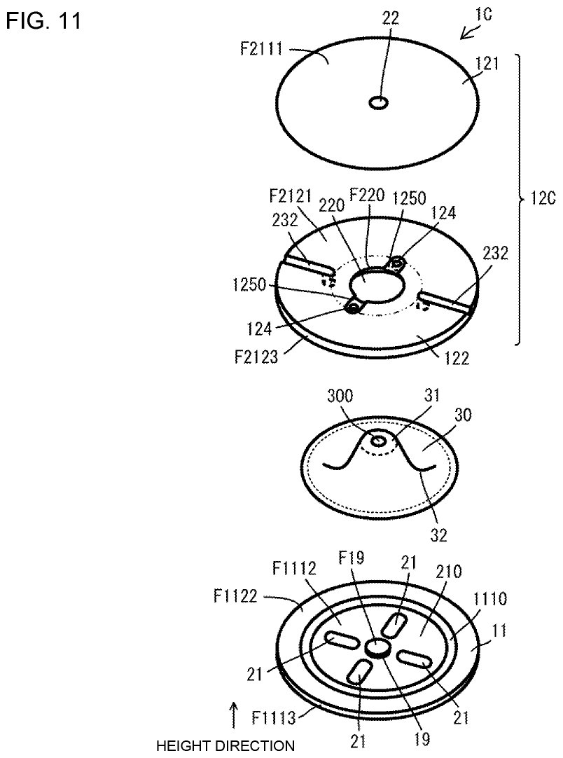

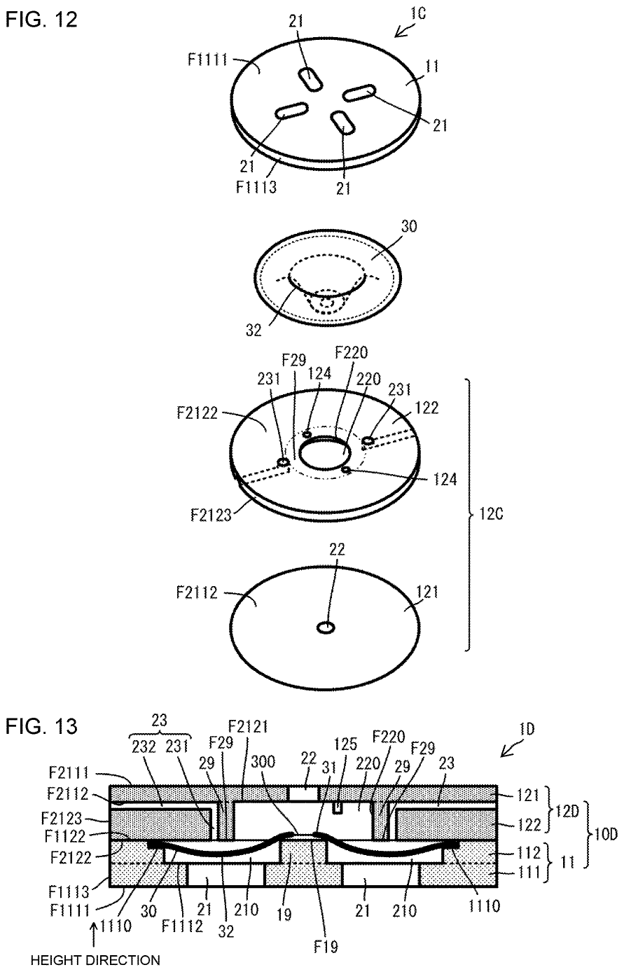

A valve according to a fourth embodiment of the present disclosure will now be described with reference to the drawings. FIGS. 11 and 12 are exploded perspective views of the valve according to the fourth embodiment. FIG. 11 is an exploded perspective view as viewed from a second-housing-member side, and FIG. 12 is an exploded perspective view as viewed from a first-housing-member side.

As illustrated in FIGS. 11 and 12, the valve 1C according to the fourth embodiment differs from the valve 1 according to the first embodiment in that a plurality of auxiliary holes 124 are provided. Other features of the valve 1C according to the fourth embodiment are similar to those of the valve 1 according to the first embodiment, and description thereof will be omitted. Description of effects of the valve 1C according to the fourth embodiment that are the same as those of the valve 1 according to the first embodiment will also be omitted.

The second housing member 12C has a plurality of auxiliary holes 124. The auxiliary holes 124 are formed in the second side wall member 122 in a region corresponding to the second valve seat 29, and are shaped to extend through the second side wall member 122 in the height direction. In other words, the second valve seat 29 has the auxiliary holes 124.

Each auxiliary hole 124 communicates with the second space 220 through a hole 1250 at one end and opens in the second top surface F29 at the other end.

When the valve 1C is viewed in the height direction, the auxiliary holes 124 are disposed at intermediate positions between the openings of the third vent holes 23 in the seventh surface F2122 in the circumferential direction of a circle centered on the center of the second side wall member 122.

In a stationary state, for example, there is a possibility that the valve diaphragm 30 is in close contact with an inner wall surface defining the second space 220 (side surface of the second valve seat 29) in a region close to the second top surface F29. With the configuration of the valve 1C, a region close to the second vent hole 22 in the second space 220 communicates with the first space 210 adjacent to the second top surface F29 and the third vent holes 23 through the holes 1250 and the auxiliary holes 124.

Thus, in a steady state in which gas is not supplied through the first vent holes 21, the valve 1C allows the second vent hole 22 and the third vent holes 23 (exhaust holes) to more reliably communicate with each other.

The other end of each auxiliary hole 124 opens in the second top surface F29. In this case, when gas is introduced through the first vent holes 21, the valve diaphragm 30 comes into contact with the second top surface F29 of the second valve seat 29. Thus, the auxiliary holes 124 are covered by the valve diaphragm 30. As a result, the valve 1C can reduce gas leakage from the first vent holes 21 to the third vent holes 23 due to the auxiliary holes 124.

### Fifth Embodiment

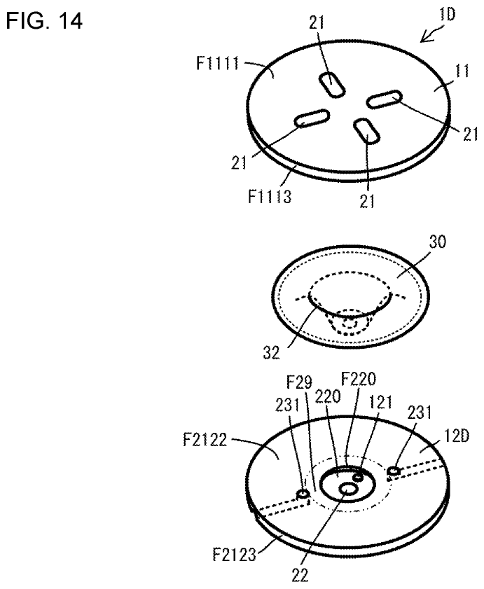

A valve according to a fifth embodiment of the present disclosure will now be described with reference to the drawings. FIG. 13 is a sectional side view of the valve according to the fifth embodiment. FIG. 14 is an exploded perspective view of the valve according to the fifth embodiment. FIG. 14 is an exploded perspective view as viewed from a first-housing-member side.

As illustrated in FIGS. 13 and 14, the valve 1D according to the fifth embodiment differs from the valve 1 according to the first embodiment in that the valve 1D includes a second housing member 12D. Other features of the valve 1D according to the fifth embodiment are similar to those of the valve 1 according to the first embodiment, and description thereof will be omitted. Description of effects of the valve 1D according to the fifth embodiment that are the same as those of the valve 1 according to the first embodiment will also be omitted.

The housing 10D of the valve 1D includes the second housing member 12D. The second housing member 12D is obtained by integrally forming the second end member 121 and the second side wall member 122 of the second housing member 12 according to the first embodiment.

The second housing member 12D includes a projection 125 in the second space 220. The projection 125 projects toward the seventh surface F2122 from the fifth surface F2112 (bottom surface defining the second space 220). The projection 125 corresponds to the “third projection” of the present disclosure.

The projection 125 is, for example, cylindrical. The projection 125 is, for example, formed integrally with other portions of the second housing member 12D.

Since the projection 125 is provided, when abnormal vibration of the valve diaphragm 30 is likely to occur, the valve diaphragm 30 comes into contact with the projection 125 before coming into contact with the bottom surface (fifth surface F2112) of the second space 220. Thus, the valve 1D can reduce abnormal vibration of the valve diaphragm 30, thereby reducing noise due to abnormal vibration.

Also, when the second end member 121 and the second side wall member 122 are formed as separate members, the projection 125 may be disposed in the second space 220 by forming the projection 125 on the second end member 121.

### Sixth Embodiment

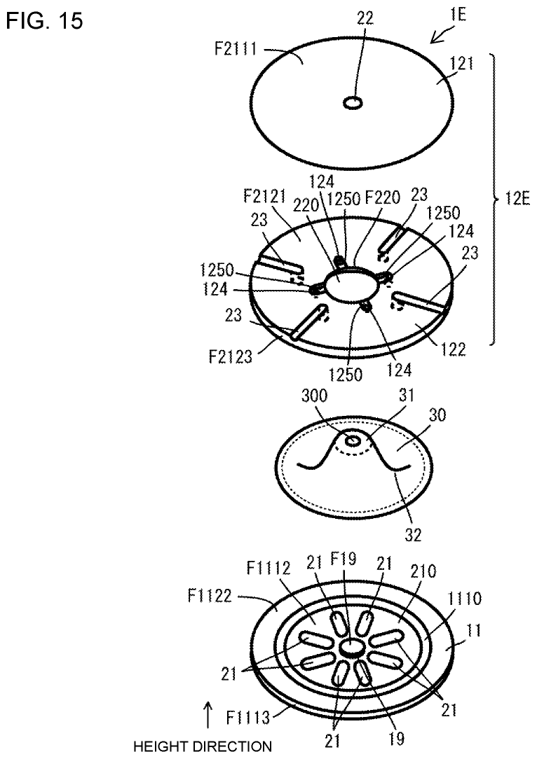

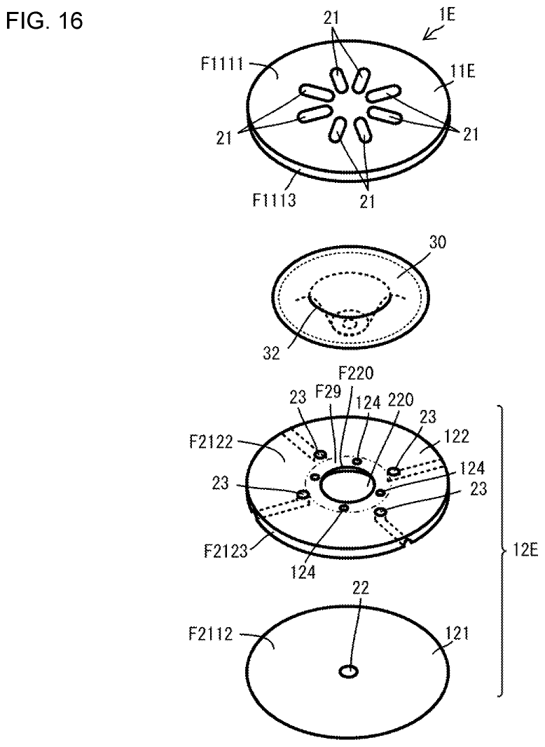

A valve according to a sixth embodiment of the present disclosure will now be described with reference to the drawings. FIGS. 15 and 16 are exploded perspective views of the valve according to the sixth embodiment. FIG. 15 is an exploded perspective view as viewed from a second-housing-member side. FIG. 16 is an exploded perspective view as viewed from a first-housing-member side.

As illustrated in FIGS. 15 and 16, the valve 1E according to the sixth embodiment differs from the valve 1C according to the fourth embodiment in the number of first vent holes 21 in the first housing member 11E, the number of third vent holes 23 in the second housing member 12E, and the number of pairs each including the auxiliary hole 124 and the hole 1250. Other features of the valve 1E are similar to those of the valve 1C, and description thereof will be omitted.

The first housing member 11E has eight first vent holes 21. The eight first vent holes 21 are arranged point-symmetrically with respect to a reference point at the center of the first housing member 11E when viewed in the height direction.

The second housing member 12E has four third vent holes 23 and four pairs each including the auxiliary hole 124 and the hole 1250. The four third vent holes 23 are arranged point-symmetrically with respect to a reference point at the center of the second housing member 12E when viewed in the height direction. The four pairs each including the auxiliary hole 124 and the hole 1250 are arranged point-symmetrically with respect to the reference point at the center of the second housing member 12E when viewed in the height direction. The four third vent holes 23 and the four pairs each including the auxiliary hole 124 and the hole 1250 are alternately arranged at equal intervals along the circumferential direction of a circle centered on the reference point.

With this configuration, the valve 1E has effects similar to those of the valve 1C.

### Seventh Embodiment

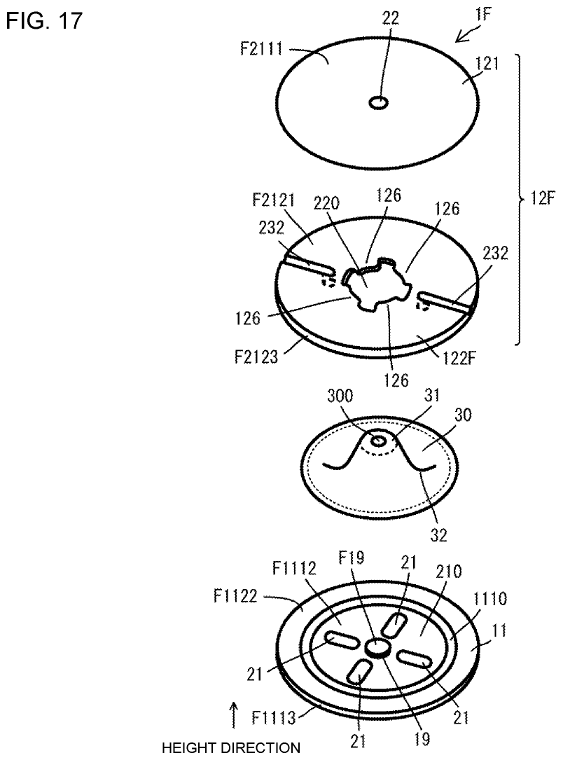

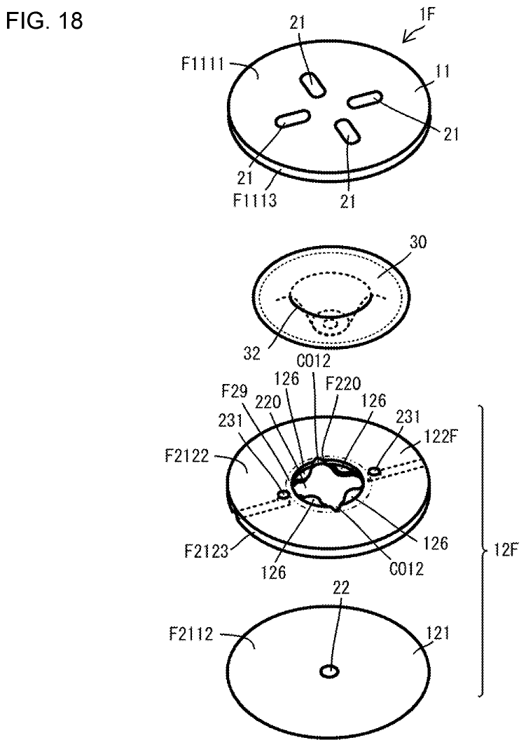

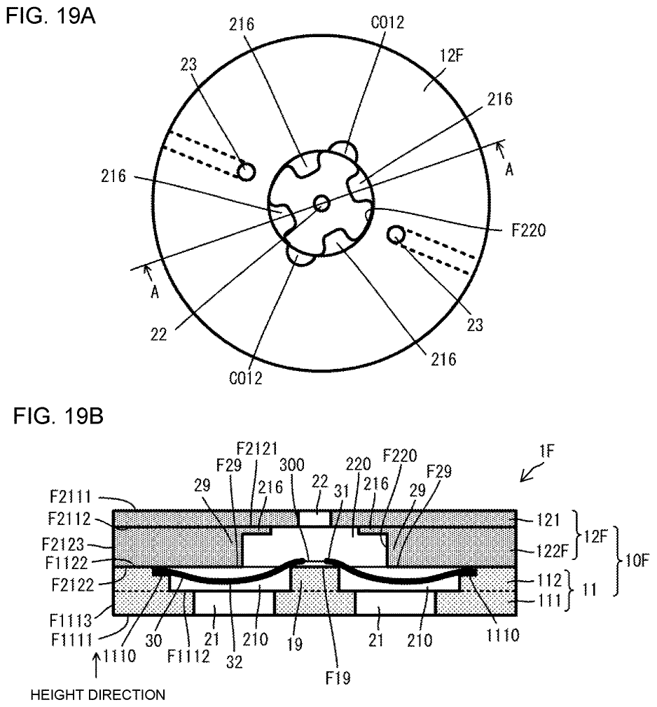

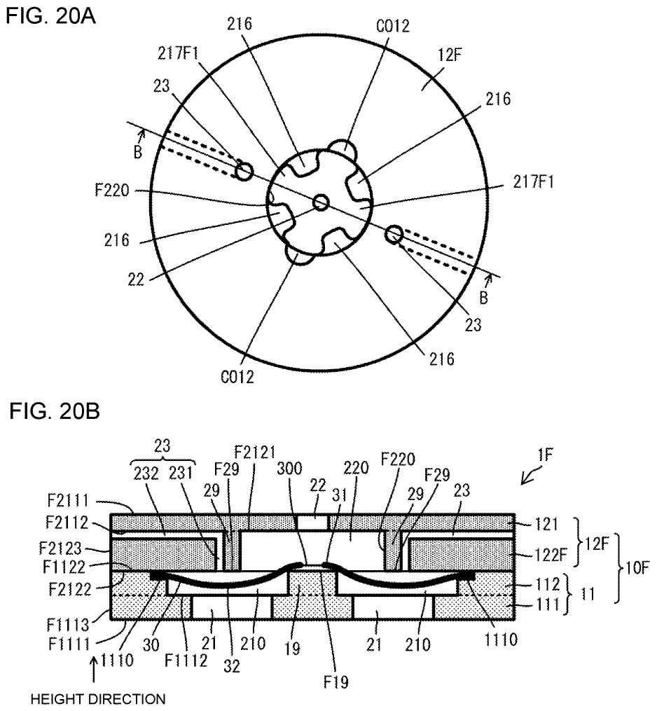

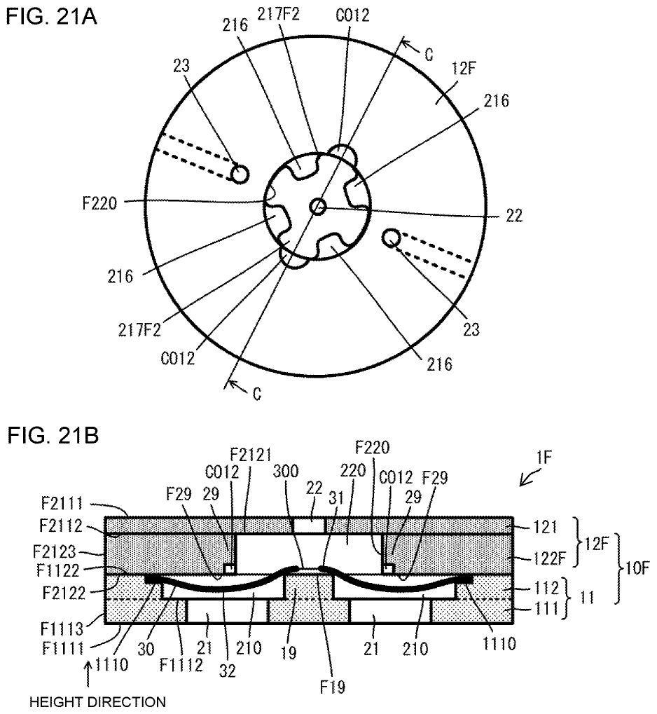

A valve according to a seventh embodiment of the present disclosure will now be described with reference to the drawings. FIGS. 17 and 18 are exploded perspective views of the valve according to the seventh embodiment. FIG. 17 is an exploded perspective view as viewed from a second-housing-member side. FIG. 18 is an exploded perspective view as viewed from a first-housing-member side. FIG. 19A is a plan view of a second housing member, and FIG. 19B is a sectional view of FIG. 19A taken along line A-A. FIG. 20A is a plan view of the second housing member, and FIG. 20B is a sectional view of FIG. 20A taken along line B-B. FIG. 21A is a plan view of the second housing member, and FIG. 21B is a sectional view of FIG. 21A taken along line C-C.

As illustrated in FIGS. 17, 18, 19A, 19B, 20A, 20B, 21A, and 21B, the valve 1F according to the seventh embodiment differs from the valve 1C according to the fourth embodiment in that the valve 1F includes a housing 10F including a second housing member 12F. Other features of the valve 1F are similar to those of the valve 1C, and description thereof will be omitted.

In the valve 1F, the second housing member 12F includes a second side wall member 122F. The second side wall member 122F includes a plurality of projecting portions 126 on the inner side surface F220. The projecting portions 126 are disposed at positions different from the positions of the third vent holes 23 in the circumferential direction along the inner side surface F220 of the second side wall member 122F. The projecting portions 126 are, for example, arranged at equal intervals in the circumferential direction of the inner side surface F220, and disposed at intermediate positions between the third vent holes 23 that are adjacent to each other in the circumferential direction.

The projecting portions 126 are arranged to be flush with the sixth surface F2121. The projecting portions 126 are thinner than the second side wall member 122F.

The projecting portions 126 are in planar contact with the fifth surface F2112 of the second end member 121.

In the valve 1F having this configuration, portions in which the projecting portions 126 overlap the second end member 121 are thicker than the second end member 121. Thus, the valve 1F has thick portions around the second vent hole 22, and these portions have a higher rigidity. As a result, the valve 1F can suppress an increase in the pressure drop.

More specifically, the following principle applies. When the fourth surface F2111 of the second end member 121 of the valve 1F faces a closed space (for example, a cuff 3 described below), gas (fluid) that continuously flows from the first vent holes 21 to the second vent hole 22 increases the pressure in the closed space. When the pressure in the closed space increases, pressure is applied to the fourth surface F2111 of the second end member 121, causing the second end member 121 to deform. The deformation of the second end member 121 causes a reduction in the second space 220.

When the second space 220 is reduced, the amount of displacement of the valve diaphragm 30 in operation is reduced. Accordingly, the flow passage defined between the first valve seat 19 and the valve diaphragm 30 is reduced, resulting in an increased pressure drop.

However, with the configuration of the valve 1F, the rigidity of the second end member 121 can be increased. Accordingly, even when pressure is externally applied to the valve 1F, deformation of the second end member 121 can be reduced. As a result, according to the valve 1F, the amount of displacement of the valve diaphragm 30 is not reduced, and an increase in the pressure drop can be suppressed.

Since multiple projecting portions 126 are provided, the second side wall member 122F includes a plurality of recesses 217F1 and a plurality of recesses 217F2 in regions in which the projecting portions 126 are not provided. The recesses 217F2 include cutouts CO12.

As illustrated in FIGS. 20A and 20B, the recesses 217F1 are disposed at the same positions as the positions of the third vent holes 23 in the circumferential direction of the inner side surface F220.

Multiple recesses 217F1 are provided, so that the projecting portions 126 are not present near the first vent holes 21 and the third vent holes 23. Thus, displacement of the valve diaphragm 30 is not impeded in regions near the first vent holes 21 and the third vent holes 23, so that the valve 1F can suppress an increase in the pressure drop. Since the valve diaphragm 30 is highly flexible, the valve diaphragm 30 can be displaced sufficiently unless the projecting portions 126 are aligned with the first vent holes 21 and the third vent holes 23 in plan view. As a result, the valve 1F can reduce the pressure drop.

As illustrated in FIGS. 21A and 21B, the recesses 217F2 are disposed at positions different from the positions of the third vent holes 23 in the circumferential direction of the inner side surface F220. The recesses 217F2 also allow the valve 1F to suppress reduction in the displacement of the valve diaphragm 30, thereby suppressing an increase in the pressure drop.

Additionally, in a stationary state, there is a possibility that the valve diaphragm 30 is in close contact with an inner wall surface defining the second space 220 (side surface of the second valve seat 29) in a region close to the second top surface F29. With the configuration of the valve 1F, a region close to the second vent hole 22 in the second space 220 communicates with the first space 210 adjacent to the second top surface F29 and the third vent holes 23 through the cutouts CO12.

Thus, in a steady state in which gas is not supplied through the first vent holes 21, the valve 1F allows the second vent hole 22 and the third vent holes 23 (exhaust holes) to more reliably communicate with each other.

The other end of each cutout CO12 opens in the second top surface F29. In this case, when gas is introduced through the first vent holes 21, the valve diaphragm 30 comes into contact with the second top surface F29 of the second valve seat 29. Thus, the cutouts CO12 are covered by the valve diaphragm 30. As a result, the valve 1F can reduce gas leakage from the first vent holes 21 to the third vent holes 23 due to the cutouts.

### Eighth Embodiment

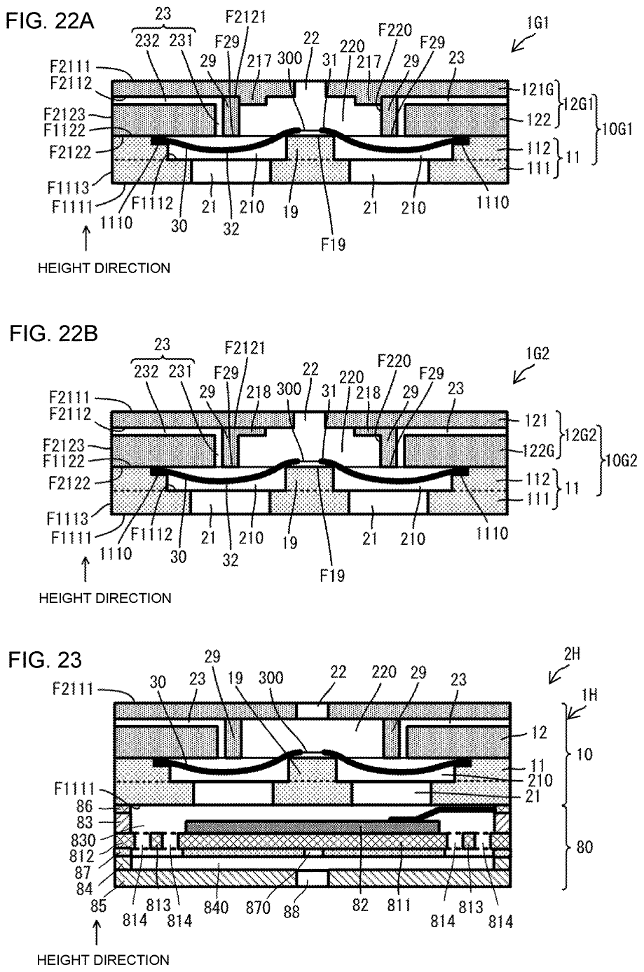

A valve according to an eighth embodiment of the present disclosure will now be described with reference to the drawings. FIGS. 22A and 22B are sectional views of the valve according to the eighth embodiment.

The valve 1G1 illustrated in FIG. 22A differs from the valve 1 according to the first embodiment in that the valve 1G1 includes a housing 10G1 including a second housing member 12G1. Other features of the valve 1G1 are similar to those of the valve 1, and description thereof will be omitted.

The second housing member 12G1 includes a second end member 121G. The second end member 121G differs from the second end member 121 according to the first embodiment in that the second end member 121G includes a thick portion 217.

The thick portion 217 is shaped to project from the fifth surface F2112. The thick portion 217 is shaped to fit into the second space 220 when the second end member 121G is joined with the second side wall member 122, that is, when the second housing member 12G1 is formed.

When the thick portion 217 is provided, the rigidity of a portion of the second end member 121G in contact with the second space 220 can be increased. Accordingly, the valve 1G1 can reduce deformation of the second end member 121G, thereby suppressing an increase in the pressure drop due to a change in the shape of the second space 220.

The valve 1G2 illustrated in FIG. 22B differs from the valve 1 according to the first embodiment in that the valve 1G2 includes a housing 10G2 including a second housing member 12G2. Other features of the valve 1G2 are similar to those of the valve 1, and description thereof will be omitted.

The second housing member 12G2 includes a second side wall member 122G. The second side wall member 122G differs from the second side wall member 122 according to the first embodiment in that the second side wall member 122G includes a thick portion 218.

The thick portion 218 is shaped to project into the second space 220 from the inner side surface F220. The thick portion 218 may be flush with the sixth surface F2121, but is not limited to this as long as the thick portion 218 is close to the sixth surface F2121.

When the thick portion 218 is provided, the rigidity of the second side wall member 122G can be increased. Accordingly, the valve 1G2 can reduce deformation of the second side wall member 122G, thereby suppressing an increase in the pressure drop due to a change in the shape of the second space 220.

### Ninth Embodiment

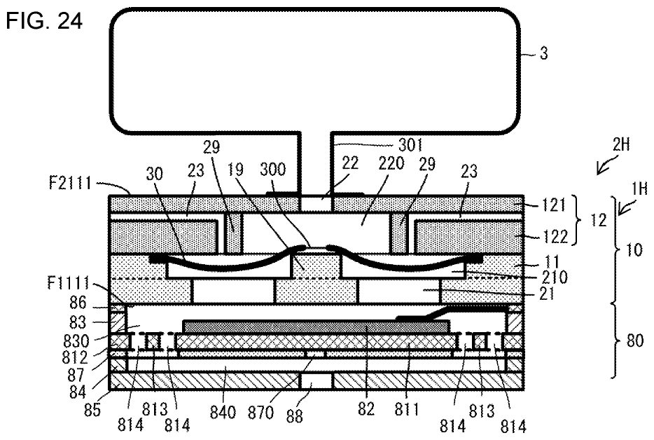

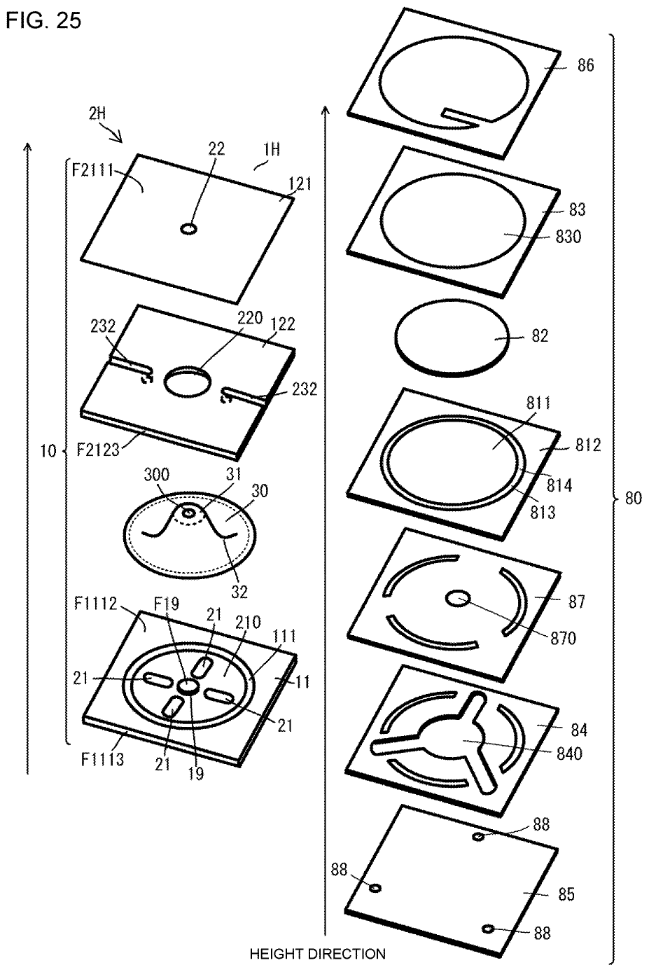

A fluid control device according to a ninth embodiment of the present disclosure will now be described with reference to the drawings. FIG. 23 is a sectional side view of the fluid control device according to the ninth embodiment. FIG. 24 is a sectional side view of the fluid control device according to the ninth embodiment with a cuff. FIG. 25 is an exploded perspective view of the fluid control device according to the ninth embodiment. FIG. 25 is an exploded perspective view as viewed from a first-housing-member side.

The fluid control device 2H according to the ninth embodiment includes a valve 1H and a pump 80.

The valve 1H is configured as with the valve 1 according to the first embodiment except that the valve 1H has a rectangular outer shape in plan view and that the first housing member 11 serves as a portion of the pump 80, and description thereof will be omitted.

A cuff 3 is attached to the fourth surface F2111 of the valve 1H. The cuff 3 includes a cylindrical neck portion 301. The internal space of the cuff 3 communicates with the second vent hole 22 in the valve 1H through a space inside the neck portion 301.

The pump 80 includes a main plate 811, a frame 812, a plurality of connecting members 813, a piezoelectric element 82, a pump-housing side wall member 83, a flow passage defining member 84, a substrate 85, a wiring electrode 86, and a flexible member 87. The first housing member 11 of the valve 1H serves also as a portion of the pump 80.

The main plate 811 has a circular shape when viewed in the height direction. When viewed in the height direction, the frame 812 is disposed to surround the main plate 811. The connecting members 813 are beam-shaped, and are disposed between the main plate 811 and the frame 812. The connecting members 813 support the main plate 811 such that the main plate 811 is capable of vibrating relative to the frame 812. The main plate 811, the frame 812, and the connecting members 813 are made of metal or the like and formed integrally with each other.

The piezoelectric element 82 has a circular shape in plan view. The piezoelectric element 82 includes a piezoelectric body and a driving conductor. The piezoelectric element 82 is disposed on one principal surface of the main plate 811. In this case, when viewed in the height direction, the center of the piezoelectric element 82 and the center of the main plate 811 substantially coincide with each other.

The pump-housing side wall member 83 has a ring shape and has a hollow 830. The pump-housing side wall member 83 is disposed between the frame 812 and the first housing member 11 of the valve 1H.

The wiring electrode 86 includes a ring-shaped portion and an extending portion. The extending portion is shaped to extend into a region surrounded by the ring-shaped portion. The wiring electrode 86 is disposed between the pump-housing side wall member 83 and the first housing member 11. The extending portion of the wiring electrode 86 is connected to the driving conductor on one principal surface of the piezoelectric element 82.

The flexible member 87, the flow passage defining member 84, and the substrate 85 are disposed on the plate including the main plate 811, the frame 812, and the connecting members 813 on a side opposite to the side on which the piezoelectric element 82 is attached in the height direction.

The flexible member 87 has a through hole 870. The flow passage defining member 84 has a through hole 840. The substrate 85 has a plurality of through holes 88. The through holes 88, the through hole 840, and the through hole 870 communicate with each other and with a plurality of through holes 814 between the connecting members 813.

The piezoelectric element 82 is deformed when a driving voltage is applied thereto via the wiring electrode 86 and the member including the main plate 811, the frame 812, and the connecting members 813. Accordingly, the main plate 811 vibrates.

The vibration allows the pump 80 to suck in gas through the through holes 88 and discharge the gas through the first vent holes 21 in the valve 1H. In this case, the valve diaphragm 30 moves away from the first valve seat 19 and comes into contact with the second valve seat 29. Thus, the first state of the valve 1H is established. In this state, the valve 1H supplies the gas introduced through the first vent holes 21 to the cuff 3 through the second vent hole 22.

When the operation of the pump 80 stops, the introduction of gas from the pump 80 into the first vent holes 21 of the valve 1H stops.

In this case, gas flows into the valve 1H from the cuff 3 through the second vent hole 22. The valve diaphragm 30 moves away from the second valve seat 29 and comes into contact with the first valve seat 19. Thus, the exhaust state included in the second state of the valve 1H is established.

As described above, the fluid control device 2H includes the valve 1H. Accordingly, effects similar to those of the valve 1 can be obtained.

### Tenth Embodiment

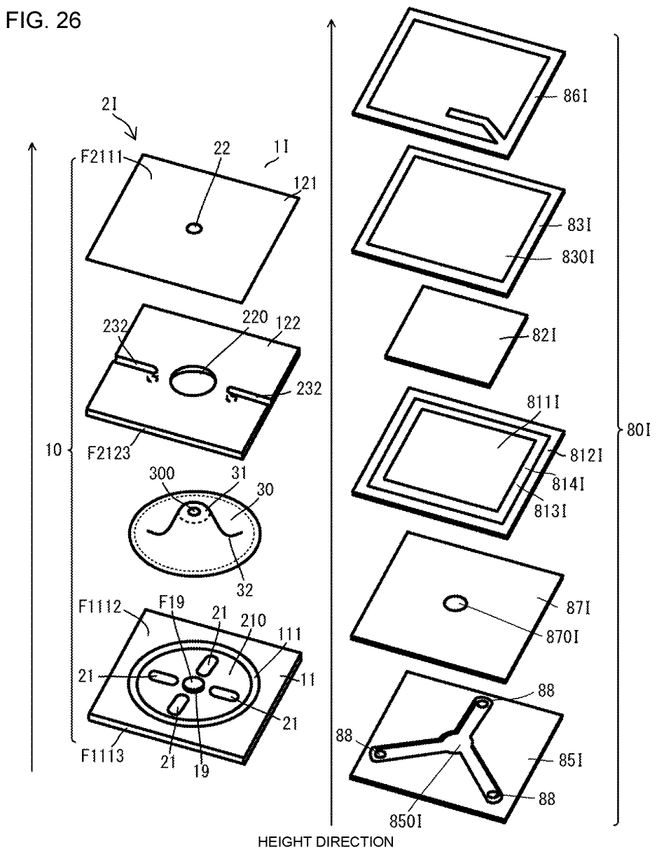

A fluid control device according to a tenth embodiment of the present disclosure will now be described with reference to the drawings. FIG. 26 is an exploded perspective view of the fluid control device according to the tenth embodiment. FIG. 26 is an exploded perspective view as viewed from a first-housing-member side.

As illustrated in FIG. 26, the fluid control device 2I according to the tenth embodiment differs from the fluid control device 2H according to the ninth embodiment in the configuration of the pump 80I. Other features of the fluid control device 2I according to the tenth embodiment are similar to those of the fluid control device 2H according to the ninth embodiment, and description thereof will be omitted.

The fluid control device 2I is a combination of a valve 1I and the pump 80I. The valve 1I is configured as with the valve 1H.

The pump 80I includes a main plate 811I, a frame 812I, connecting members 813I, a piezoelectric element 82I, a pump-housing side wall member 83I, a substrate 85I, a wiring electrode 86I, and a flexible member 87I. The first housing member 11 of the valve 1I serves also as a portion of the pump 80I.

The main plate 811I and the frame 812I have rectangular shapes when viewed in the height direction. The connecting members 813I are disposed between the main plate 811I and the frame 812I. The connecting members 813I support the main plate 811I such that the main plate 811I is capable of vibrating relative to the frame 812I.

The flexible member 87I has a through hole 870I.

The substrate 85I has a recess 850I and a plurality of through holes 88. The recess 850I and the through holes 88 communicate with each other. The substrate 85I is a member having the functions of the substrate 85 and the flow passage defining member 84 in the pump 80 according to the ninth embodiment.

With the above-described configuration, the pump 80I has a function similar to that of the pump 80. Since the fluid control device 2I includes the pump 80I and the valve 1I, as with the fluid control device 2H, effects similar to those of the valve 1 can be obtained.

In the above-described embodiments, when the valve diaphragm 30 is displaced in the height direction of the internal space by gas flowing through the internal space, the shapes of the first portion 31 and the second portion 32 may be maintained, or the valve diaphragm 30 may be deformed.

In the above-described embodiments, the valve diaphragm 30 has a circular shape when viewed in the height direction, and the internal space also has a circular shape when viewed in the height direction. However, the shape of the valve diaphragm 30 when viewed in the height direction and the shape of the internal space when viewed in the height direction may be elliptical, oblong, or polygonal (in particular, regular polygonal).

In the above-described embodiments, the first top surface F19 may be closer to the second vent hole 22 than the seventh surface F2122 in the height direction of the housing 10. In this case, the valve diaphragm 30 is more reliably in contact with the first top surface F19 in the exhaust state.

In the above-described embodiments, the ridge along the outer peripheral edge of the first top surface F19 of the first valve seat 19 and the ridge of the second top surface F29 of the second valve seat 29 may be chamfered. In this case, sharp ridges do not come into contact with the valve diaphragm 30, so that the valve 1 can reduce damage to the valve diaphragm 30.

### Variations of Cuff Structure

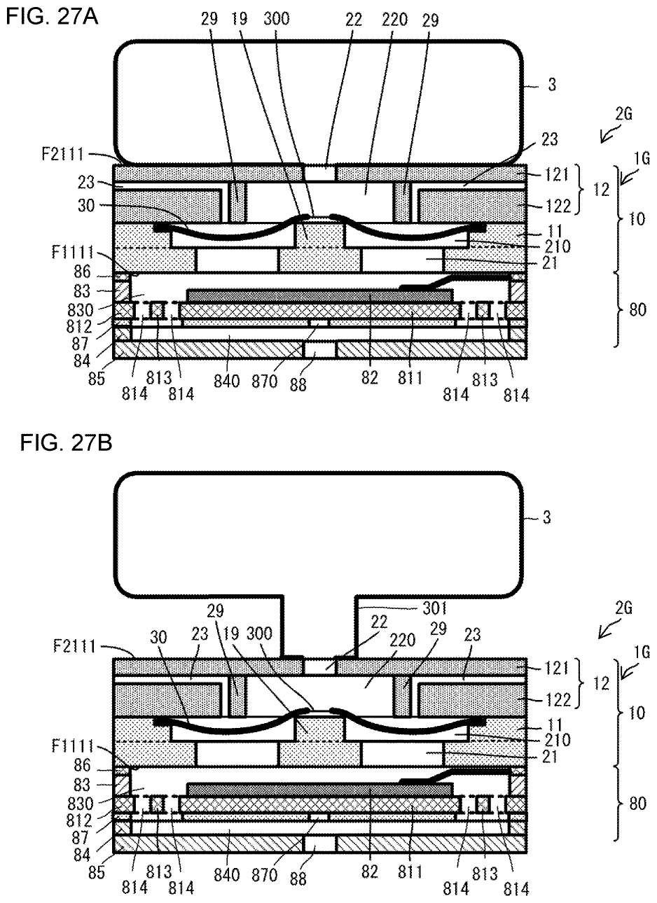

FIGS. 27A and 27B are sectional side views of cuffs having shapes according to variations.

In the configuration illustrated in FIG. 27A, the cuff 3 with no cylindrical neck portion is connected to the fluid control device 2G. In the configuration illustrated in FIG. 27B, the cuff 3 includes a neck portion 301 with an opening area larger than the opening area of the second vent hole 22.

Thus, the cuff 3 may have various shapes as long as the cuff 3 is configured such that the internal space thereof communicates with the second vent hole 22.
1, 1A, 1B, 1BX, 1C, 1D, 1E, 1F, 1G1, 1G2, 1H, 1I: valve
2H, 2I: fluid control device
3: cuff
10, 10A, 10B, 10BX, 10D, 10F, 10G1, 10G2: housing 11, 11A, 11B, 11BX: first housing member
12, 12B, 12C, 12D, 12E, 12F, 12G1, 12G2: second housing member
18, 18X: projection
19: first valve seat
21: first vent hole
22: second vent hole
23: third vent hole
29: second valve seat
30: valve diaphragm
31: first portion
32: second portion
80, 80I: pump
82, 82I: piezoelectric element
83, 83I: pump-housing side wall member
84: flow passage defining member
85, 85I: substrate
86, 86I: wiring electrode
87, 87I: flexible member
88: through hole
111: first end member
112: first side wall member
121, 121G: second end member
122, 122F, 122G: second side wall member
1110: recess
119: projection
113: groove
123: recess
124: auxiliary hole
125: projection
126: projecting portion
217F1, 217F2: recess
210: first space
220: second space
231: vertical hole
232: horizontal hole
300: through hole
301: neck portion
330: outer edge portion
811, 811I: main plate
812, 812I: frame
813, 813I: connecting member
814: through hole
830: hollow
831: pump-housing side wall member
840: through hole
850I: recess
870: through hole
1250: hole
CO12: cutout
F1111: first surface
F1112: second surface
F1113: outer side surface
F1122: third surface
F2111: fourth surface
F2112: fifth surface
F2121: sixth surface
F2122: seventh surface
F2123: outer side surface
F220: inner side surface
F19: first top surface
F29: second top surface

1. A valve comprising:
a housing; and
a valve diaphragm,
wherein the housing includes a first housing member and a second housing member,
wherein the first housing member includes
a first end member including a first surface and a second surface, and
a first side wall member having a ring shape and directly or indirectly connected to the first end member, the first side wall member including a third surface on a side opposite to a side connected to a portion of the second surface,
wherein the second housing member includes
a second end member including a fourth surface and a fifth surface facing a portion of the second surface, and
a second side wall member having a ring shape and directly or indirectly connected to the second end member, the second side wall member including a sixth surface facing or joined to a portion of the fifth surface and a seventh surface facing or joined to a portion of the third surface of the first side wall member,
wherein the first end member includes
a plurality of first vent holes through which the first surface and the second surface communicate with each other, and
a first valve seat connected to the second surface and disposed within the ring of the first side wall member in a plan view of the second surface,
wherein the first valve seat includes a first top surface,
wherein the first top surface is positioned closer to the fifth surface than the second surface in a thickness direction of the first housing member,
wherein the second end member has a second vent hole through which the fourth surface and the fifth surface communicate with each other,
wherein the second side wall member includes
an exhaust hole communicating with the seventh surface, and
a second valve seat disposed between an inner side surface of the ring of the second side wall member and the exhaust hole in a front view of the fourth surface, the second valve seat including a second top surface on a side on which the seventh surface is provided,
wherein the valve diaphragm
is disposed in the ring of the first side wall member and the ring of the second side wall member, and
includes a first portion overlapping the first valve seat, a second portion overlapping the second valve seat, and an outer edge portion positioned on an outer peripheral side of the second portion when viewed in a height direction in which the first housing member and the second housing member are arranged,
the outer edge portion being held between the first housing member and the second housing member, and
the second portion being closer to the first surface than the first portion when viewed in a lateral direction orthogonal to the height direction while the outer edge portion is held between the first housing member and the second housing member, and
wherein each of a thickness of the first portion and a thickness of the second portion is greater than a thickness of the outer edge portion.

2. The valve according to claim 1,
wherein a height of a portion in which the outer edge portion is held between the first housing member and the second housing member is less than a thickness of the valve diaphragm when the valve diaphragm is not held between the first housing member and the second housing member.

3. The valve according to claim 1,
wherein the valve diaphragm has a shape such that
the valve diaphragm is separated from the first valve seat and in contact with the second valve seat in a first state in which gas is introduced through the first vent holes, and
the valve diaphragm is in contact with the first valve seat and separated from the second valve seat in a second state in which the gas is not introduced through the first vent holes.

4. The valve according to claim 1,
wherein the second valve seat is shaped to surround the first valve seat when viewed in the height direction.

5. The valve according to claim 4,
wherein the second side wall member includes a second-side-wall-member recess recessed from the seventh surface in a region outward from the exhaust hole when viewed in the height direction,
wherein the first housing member includes a first projection at a position overlapping the second-side-wall-member recess when viewed in the height direction, and
wherein a portion of the valve diaphragm is held between a bottom surface of the second-side-wall-member recess and the first projection.

6. The valve according to claim 4,
wherein the first housing member includes
a first projection at a position overlapping the seventh surface when viewed in the height direction, the first projection including a top surface at a position closer to the second surface than the third surface in the height direction, and
a groove disposed closer to an outer side surface of the first housing member than the first projection and recessed from the third surface, and
wherein an outer peripheral edge of the valve diaphragm is disposed in the groove, and a portion of the valve diaphragm is held between the seventh surface and the first projection.

7. The valve according to claim 4,
wherein the first housing member includes a first-member recess recessed from the third surface at a position overlapping the second side wall member when viewed in the height direction, and
wherein a portion of the valve diaphragm is held between a bottom surface of the first-member recess and the seventh surface.

8. The valve according to claim 4,
wherein the first housing member includes a plurality of second projections projecting from the second surface toward the third surface, and
wherein a portion of the valve diaphragm is held between the seventh surface and the plurality of second projections.

9. The valve according to claim 1,
wherein the second valve seat has an auxiliary hole having one end communicating with a space within the ring of the second side wall member and another end opening in the second top surface.

10. The valve according to claim 1,
wherein the exhaust hole and one of the first vent holes have an overlapping region when viewed in the height direction.

11. The valve according to claim 1,
wherein the second housing member includes a third projection projecting from the fifth surface toward the valve diaphragm.

12. The valve according to claim 1,
wherein the first top surface is closer to the fourth surface than the second top surface in the height direction.

13. The valve according to claim 1,
wherein the second side wall member includes an inner side surface of the ring shape and a projecting portion projecting from the inner side surface toward a center of the ring shape.

14. The valve according to claim 1,
wherein the second side wall member includes a recess recessed from the inner side surface and extending through the sixth surface and the seventh surface.

15. The valve according to claim 14,
wherein the recess is positioned to coincide with one of the first vent holes or the exhaust hole in a circumferential direction along the inner side surface.

16. A fluid control device comprising:
the valve according to claim 1; and
a pump having a discharge hole communicating with the first vent holes.

17. The valve according to claim 2,
wherein the valve diaphragm has a shape such that
the valve diaphragm is separated from the first valve seat and in contact with the second valve seat in a first state in which gas is introduced through the first vent holes, and
the valve diaphragm is in contact with the first valve seat and separated from the second valve seat in a second state in which the gas is not introduced through the first vent holes.

18. The valve according to claim 2,
wherein the second valve seat is shaped to surround the first valve seat when viewed in the height direction.

19. The valve according to claim 3,
wherein the second valve seat is shaped to surround the first valve seat when viewed in the height direction.

20. The valve according to claim 2,
wherein the second valve seat has an auxiliary hole having one end communicating with a space within the ring of the second side wall member and another end opening in the second top surface.
